(19) United States
(12) Patent Application Publication
(10) Pub. No.: US 2025/0087907 A1
(43) Pub. Date: Mar. 13, 2025

(54) SUPPORT SLEEVE SYSTEM, METHOD OF ASSEMBLING A SUPPORT SLEEVE SYSTEM, METHOD OF ASSEMBLING A THREADED CABLE GLAND, CABLE AND THREADED CABLE GLAND

(71) Applicant: PFLITSCH GMBH & CO.KG, Hückeswagen (DE)

(72) Inventors: Martin LECHNER, Lindlar (DE); Robert VON OTTE, Schalksmühle (DE)

(73) Assignee: PFLITSCH GMBH & CO.KG, Hückeswagen (DE)

(21) Appl. No.: 18/899,282

(22) Filed: Sep. 27, 2024

Related U.S. Application Data
(63) Continuation of application No. PCT/EP2023/058183, filed on Mar. 29, 2023.

(30) Foreign Application Priority Data
Mar. 29, 2022 (DE) 102022107368.8

(51) Int. Cl. H01R 4/18; H01R 43/04

(52) U.S. Cl. CPC H01R 4/183; H01R 43/04

(57) ABSTRACT

The invention relates to a support sleeve system for use as a counter bearing and/or contact surface for electrical contacting a cable armoring. The support sleeve system comprises at least one fixing means and one support means, wherein the support means can be arranged under the cable armoring and the fixing means for fixing the support means can be applied to at least one end section of the cable armoring.

### CROSS-REFERENCE TO RELATED APPLICATIONS

This application is a continuation of International Application No. PCT/EP2023/058183, filed on Mar. 29, 2023, which claims priority to and the benefit of DE 102022107368.8, filed on Mar. 29, 2022. The disclosures of the above applications are incorporated herein by reference.

### FIELD

The present disclosure relates to a support sleeve system, a method for assembling a support sleeve system, a method for assembling a threaded cable gland, a cable with a support sleeve system and a threaded cable gland.

### BACKGROUND

The statements in this section merely provide background information related to the present disclosure and may not constitute prior art.

Various embodiments for contacting cable armoring are known from the state of the art. For example, CH 690 809 A5 discloses a connection element for shielded conductors with a conical clamping sleeve that is arranged under a cable armoring. The cable armoring is clamped between a ring element of the end fitting part and the conical clamping sleeve when an end fitting part is screwed together with a ring nut.

A disadvantage of the contacts known from the prior art is that they are complex to install and cannot be reused. For example, the clamping sleeves known from the prior art, which can be arranged under the cable armoring, are usually damaged when the cable armoring is jammed. If, for example, a threaded cable gland is loosened again, the damaged cable armoring cannot be contacted again or the contact surface is reduced to an unfavorable extent, for example if individual strands of the cable armoring are broken during clamping. The clamping sleeves known from the prior art can also be lost. In particular, during reassembly, the clamping sleeve can be lost when the cable gland is removed.

### SUMMARY

This section provides a general summary of the disclosure and is not a comprehensive disclosure of its full scope or all of its features.

The object of the invention is therefore to provide an improved support sleeve system for use as a counter bearing and/or contact surface for electrical contacting of a cable armoring. In particular, the object of the invention is to provide a support sleeve system that can be pre-assembled on a cable. In particular, the object of the invention is to provide an improved method for assembling a support sleeve system, an improved method for assembling a threaded cable gland, an improved cable with a support sleeve system and an improved threaded cable gland. Preferably, the object of the invention is to provide a support sleeve system which enables convenient assembly and disassembly or multiple assembly of an armored cable.

The object is solved according to the invention by means of a support sleeve system for use as a counter-bearing and/or contact surface for an electrical contacting of a cable armoring, at least comprising a fixing means and a support means, wherein the support means can be arranged under the cable armoring and the fixing means for fixing the support means can be applied to at least one end section of the cable armoring.

Furthermore, the object of the invention is solved by means of a method for assembling an above-mentioned support sleeve system comprising the steps of: stripping a cable to expose a cable armoring; threading a fixing means of the support sleeve system and a support means of the support sleeve system onto the cable in such a way that the support means is arranged at least partially under the cable armoring and the fixing means is arranged at least partially over an end section of the cable armoring; and force-fit and/or form-fit connection of the fixing means to the cable armoring.

Furthermore, the object of the invention is solved by means of a method for assembling a threaded cable gland comprising the steps of assembly of a support sleeve system on a cable as mentioned above, threading a threaded cable gland onto the cable in such a way that at least one contact element makes electrical contact with a cable armoring in the region of a support means of the support sleeve system and/or makes electrical contact with a fixing means of the support sleeve system.

Furthermore, the object according to the invention is solved by means of a cable with an above-mentioned support sleeve system, wherein a support means of the support sleeve system is arranged at least partially under a stripped cable armoring of the cable and wherein an end section of the cable armoring is arranged in a fixing means of the support sleeve system and is fixed by means of the fixing means.

Furthermore, the object according to the invention is solved by means of a threaded cable gland with an above-mentioned cable with a support sleeve system, wherein at least one contact element of the threaded cable gland contacts a cable armoring of the cable and/or a support sleeve system.

A support sleeve system, which can preferably be pre-assembled on a cable, is proposed for use as a counter-bearing and/or contact surface for electrical contacting of a cable armoring. The support sleeve system comprises at least one fixing means and one support means, wherein the support means can be arranged under the cable armoring and the fixing means for fixing the support means can be applied to at least one end section of the cable armoring.

Unless otherwise specified, the support sleeve system is described in an unassembled state.

An advantage of the proposed support means system is that an outer diameter of the cable armoring of a cable arranged around the support means can be defined, so that the contacting properties for different cables with the same support means or the same support sleeve system can be designed in the same way. It is particularly advantageous that the support sleeve system can be pre-assembled on the cable. This allows the cable with pre-assembled support sleeve system to be conveniently fitted with a threaded cable gland, for example. If the threaded cable gland is removed from the cable, the reinforcement is protected by the support sleeve system. Reinstallation in a threaded cable gland, even one with a different design, is possible in particular with the same contact properties of the cable armoring and/or the support sleeve system. Contacting properties are, for example, an outer diameter of the cable armoring, a conductivity and/or a material hardness of the support means and/or fixing means configured as a counter bearing.

The support sleeve system comprises a fixing means. Preferably, the fixing means can be used to apply a radial force to the cable armoring that is substantially uniform over a circumference of the cable armoring. Preferably, the cable armoring and support means, and more preferably the cable and support sleeve system, can be fixed by means of the fixing means in such a way that the cable armoring and support means or support means system and cable cannot be displaced relative to each other. Preferably, the fixing means is a means for radially fixing the cable armoring to the support means. Preferably, the cable armoring can only be fixed to the support means by means of the fixing means. Preferably, the fixing means is configured in one piece. Advantageously, no means other than the fixing means is required to fix the cable armoring to the support means. Preferably, the support sleeve system can be attached to the cable by means of the fixing means independently of a threaded cable gland, for example. Further preferably, the support sleeve system can be permanently attached to the cable by means of the fixing means. For the purposes of the invention, “permanent” means that the support sleeve system can be arranged on the cable in a substantially undetachable manner. Preferably, a permanent arrangement of the support sleeve system on the cable is configured in such a way that at least the fixing means must be destroyed in order to release the support sleeve system from the cable.

In one embodiment, the fixing means is configured as a crimping sleeve or snap ring. For example, the snap ring comprises a spring-elastic, slotted sleeve. In a further embodiment, the fixing means is configured as a shrink tube, adhesive tape, cable tie or similar. Advantageously, a shrink tube is a cost-effective design by means of which the cable armoring can be arranged, preferably permanently, on the support means. The fixing means is preferably configured as a crimping sleeve. A fixing means configured as a crimping sleeve has the advantage that it can be used to permanently attach the support sleeve system to the cable. Multiple assembly and disassembly of the cable, for example in a threaded cable gland, is therefore easily possible without the support sleeve system being lost or the cable armoring being damaged.

Crimping in the sense of the invention is understood to mean a plastic deformation which is produced by a preferably radial pressure on the part to be crimped. In particular, crimping is to be understood as crimping in which plastic deformation is used to join parts together, preferably in a force-fit and/or form-fit manner. A crimping sleeve is therefore a sleeve that is configured to be plastically deformed, preferably in order to join it to the cable, the cable armoring and/or the support means.

The fixing means, preferably configured as a crimping sleeve, preferably comprises a plastically deformable material, preferably an electrically conductive material, for example a metal, preferably a brass alloy, steel, bronze and/or brass. In one embodiment, the fixing means and the support means have the same materials. The fixing means configured as a snap ring preferably comprises an elastically deformable material, for example spring steel or a plastic, preferably an electrically conductive plastic. Preferably, the fixing means comprises a rigid material. Preferably, a rigid material cannot be deformed by contacting through a contact element provided. A rigid material has the advantage that contact can be made with a defined pressure, preferably without changing the outer diameter of the support means or the cable armoring in the contact region. Preferably, the fixing means comprises an electrically conductive material, for example a metallic material. The advantage of an electrically conductive material is that the fixing means can be contacted in particular to conduct electrical currents, for example from a contact element of a threaded cable gland. Another advantage is that this creates an enlarged, defined contact surface compared to a design in which only the cable armoring can be electrically contacted. In one embodiment, the fixing means, which is preferably configured as a shrink tube, comprises at least one material selected from a group comprising thermoplastic elastomers, polyolefins, polyvinyl chloride, polytetrafluoroethylene, ethylene-propylene-diene rubber and/or polyimides.

Exemplary enumerations are not to be regarded as exhaustive in the sense of the invention but can be supplemented within the framework of general technical knowledge.

Advantageously, the fixing means can be used to fix the support means. Further advantageously, the fixing means is used to fix the cable armoring to the support means. In particular, the fixing means is used to prevent the support means from slipping out from under the cable armoring. In a further advantageous embodiment, in which the fixing means can be squeezed or crimped and this can be arranged at least partially over the support means, the support means can also be squeezed so that the support means can be prevented from slipping on the cable.

The fixing means can be applied to an end section of the cable armoring. Preferably, an end section of the cable armoring is at least partially covered by the fixing means. Advantageously, damage to the end section of the cable armoring or a stripped cable armoring can thus be prevented. For example, a cable with a stripped cable armoring can be prepared with the support sleeve system for assembly, for example with a threaded cable gland, at a later point in time. For example, fraying or breaking of the ends of the cable armoring can be prevented by the fixing means.

In the sense of the invention, an end section of the cable armoring is to be understood as a stripped end section of the cable armoring, preferably a free end of the cable armoring. Preferably, the end section can be used for making contact with a threaded cable gland, preferably with a contact element in a threaded cable gland. Preferably, the end section of the cable armoring is the section under which the support sleeve can be pushed.

In one embodiment, the fixing means has an inner wall. Preferably, the inner wall is cylindrical. The inner wall is also preferably electrically conductive. Preferably, the inner wall is configured to ensure preferably electrical contact with the cable armoring. Advantageously, at least the inner wall can be used to conduct electrical currents.

In one embodiment, it is provided that the fixing means comprises a receptacle for the at least one end section of the cable armoring. The receptacle can preferably be a through-opening of the preferably hollow-cylindrical fixing means. Preferably, the fixing means is tubular or ring-shaped. Preferably, the fixing means forms an annular space that serves as a through-opening for a cable. Preferably, the fixing means comprises an inner wall that surrounds the receptacle. Preferably, the receptacle extends centrally through the fixing means along its longitudinal axis. Advantageously, the cable armoring can be easily inserted into the receptacle. Preferably, the cable with the stripped cable armoring can be arranged in the receptacle. It is also preferable that the support sleeve can be arranged in the receptacle of the fixing means.

The support sleeve system comprises a support means that can be arranged under a cable armoring. A defined diameter of the cable armoring is preferably ensured by means of the support means, preferably in a contact region in which, for example, a contact element of a threaded cable gland should preferably make electrical contact with the cable armoring in an intended use.

Preferably, the support means is a cylindrical sleeve, preferably a hollow-cylindrical sleeve. Preferably, the support means comprises a circular-cylindrical outer sleeve. Further preferably, the support means comprises a circular-cylindrical inner sleeve. The advantage of the cylindrical embodiment is that a contact region is formed over a length of the support means, which preferably has the same diameter.

Preferably, the support means comprises a rigid material that is preferably not deformable under at least the pressure caused by a contact element, for example of a threaded cable gland. This advantageously ensures that the contact or the contact force exerted by the contact element remains the same. Preferably, the contact force remains substantially the same over the service life of a contact element, for example a threaded cable gland, connected to the cable that has the support sleeve system. Further advantageously, the contact between the contact element and the cable armoring along the support sleeve has the same contact properties. This creates a large tolerance range in which the contact element can contact the cable armoring.

The term “substantially” indicates a tolerance range that is justifiable for the person skilled in the art from an economic and technical point of view, so that the corresponding feature can still be recognized or realized as such.

The support means preferably comprises an electrically conductive material, for example a metal, preferably copper, a copper alloy, steel, brass, an electrically conductive plastic and/or bronze. The advantage of the electrically conductive material is that it improves the dissipation of electrical currents from the cable armoring. The electrically conductive support means can promote the flow of electrical current, particularly in the case of cable armoring that is configured with a wide mesh. The material of the support means can be the same or different to the material of the fixing means.

In one embodiment, it is provided that the fixing means and the support means are configured in one or two pieces. One-piece in the sense of the present invention means that the support means and the fixing means form a unit, so that the fixing means is preferably held pre-assembled on the support means. In an embodiment in which the support means and the fixing means are configured in one piece, the fixing means is, for example, soldered or welded to the support means. The advantage of the embodiment is that the support means and fixing means are undetachably connected to each other. Preferably, the receptacle of the fixing means for the cable armoring is formed by an annular space between the inner wall of the fixing means and the outer wall of the support means. Preferably a shoulder forms a bottom portion of the annular space. Preferably, the annular space comprises a base against which the cable armoring can preferably be abutted. Advantageously, by inserting the cable armoring into the annular space between the support means and the fixing means, a defined length, preferably starting from one end of the cable armoring, can be fixed by the fixing means and/or contacted by the support means. Preferably, the support means and/or the fixing means comprise a stop. Advantageously, this allows the cable armoring to be positioned precisely.

In one embodiment, it is provided that the support means can be arranged in the fixing means. Preferably, the support means can be arranged in the receptacle of the fixing means. Preferably the fixing means can be arranged above the support means. For example, the fixing means can be threaded onto the cable during assembly. The support means can also be threaded onto the cable, whereby this can be arranged at least partially under the cable armoring. If, for example, the fixing means is threaded onto the cable before the support means and pushed further onto the cable than the support means in a first assembly step, the latter can be pushed into a target position after the support means has been arranged at least partially under the cable armoring. This is advantageously effected by smoothing the end section of the cable armoring, which may have been widened or bent by the arrangement of the support means underneath it.

The nested embodiment of support means and fixing means advantageously creates a compact system. Furthermore, a defined electrical connection is advantageously created between the support means and the fixing means and/or between the cable armoring and the fixing means, in particular if the fixing means itself is at least partially crimped (for example crimped) on the support means and/or the fixing means exerts a radial force on the cable armoring.

In one embodiment, it is provided that the cable armoring can be crimped to the support means by means of the fixing means. In a further embodiment, it is provided that the cable armoring can be pressed onto the support means by means of the fixing means, i.e. that a force is applied by means of the fixing means, which holds the cable armoring on the support means at least in a force-locking manner. Advantageously, a defined, preferably permanent connection of the cable armoring to the support sleeve system can thus be achieved. Particularly advantageous is the connection of the cable armoring and the support sleeve system for pre-assembly of the cable, for safe assembly and/or multiple disassembly and reassembly of the cable, preferably provided with a threaded cable gland.

In one embodiment, the support means comprises an outer wall. In one embodiment, it is provided that the fixing means comprises an inner wall and the support means comprises an outer wall, wherein the inner wall and the outer wall can be arranged substantially concentrically to one another. In particular, the support means and fixing means can be arranged concentrically to one another if they can be crimped or pressed together. For example, support means and fixing means can be arranged concentrically to one another if the cable armoring can be fixed to the support means by means of the fixing means, for example by being crimped or pressed together with the support means.

In one embodiment, it is provided that the support means comprises an outwardly projecting, at least partially circumferential shoulder on which the fixing means can be placed. Preferably, the shoulder comprises a radially outwardly projecting material accumulation and/or a wall. Furthermore, preferably, the shoulder is configured to be completely circumferential. Furthermore, preferably, the shoulder is arranged on an outer wall of the support means. Furthermore, it is preferred that the shoulder forms one end face of the support means. The shoulder advantageously enables the support means and fixing means to be positioned precisely in relation to one another. Preferably, the fixing means can be placed on the at least partially circumferential shoulder of the support means, in particular if the support means is arranged in the receptacle of the fixing means. Furthermore, assembly of the support sleeve system is advantageously simplified by the shoulder, as this represents an assembly aid or positioning aid. Preferably, the shoulder comprises the function of a stop. Preferably, the shoulder forms the stop for the end of the cable armoring. Furthermore, the cable armoring can be optimally positioned between the support means and the fixing means, for example by pushing the support means under the cable armoring until the end section or the free end of the cable armoring abuts against the shoulder or ends near it and is preferably completely covered by the fixing means.

In an exemplary embodiment of the support sleeve system, this comprises a sleeve-shaped support means and a sleeve-shaped fixing means, wherein the support means can preferably be accommodated in a receptacle of the fixing means. For assembling the support sleeve system, the support means of the support sleeve system can be arranged under an end section of a cable armoring, preferably under a free end of the cable armoring, of a cable. The cable armoring can thus be expanded in a defined manner in the region of the support sleeve system. The fixing means, which is configured as a crimping sleeve by way of example, is partially arranged over the end section. As long as the fixing means is in an uncrimped state, it can be freely moved or positioned over the cable armoring and the support means.

The fixing means can be arranged in an assembly position, for example. For easy arrangement of the fixing means in the assembly position on the support means, the support means comprises a circumferential shoulder at its end protruding from the cable armoring. The shoulder protrudes radially outwards to such an extent that the uncrimped fixing means can be placed on it. This enables optimum positioning of the fixing means to the support means. The end section of the cable armoring is exemplarily arranged in a receptacle of the fixing means. The inner wall of the fixing means and the outer wall of the support means enclose the end section of the cable armoring.

In an exemplary assembled state, the fixing means is crimped with the cable armoring and the support means in the assembly position. In this way, the cable armoring is securely electrically contacted and the support sleeve system is firmly connected to the cable. In the exemplary crimped state of the fixing means, the support means is also deformed by the crimping of the fixing means, whereby a force-fit and form-fit connection is created between the fixing means and the support means. Furthermore, the cable armoring is permanently held between the support means and the fixing means.

Furthermore, a method for assembling, preferably for pre-assembling, a support sleeve system described above is proposed, which comprises the steps of: stripping a cable to expose a cable armoring; threading a fixing means of the support sleeve system and a support means of the support sleeve system onto the cable in such a way that the support means is arranged at least partially under the cable armoring and the fixing means is arranged at least partially over an end section of the cable armoring; and force-fit and/or form-fit connection of the fixing means to the cable armoring.

Advantageously, the cable pre-assembled in such a way is transported to a place of use in one embodiment. In one embodiment, it is provided that the fixing means is connected to the cable in a force-fit and/or form-fit manner. In one embodiment, it is provided that the fixing means is non-positively and/or positively connected to the support means. For example, the fixing means is crimped. In a further embodiment, in which, for example, the fixing means is configured as a snap ring, the fixing means is expanded elastically and, after the cable armoring has been arranged in the receptacle of the fixing means, is released. In a further embodiment, it is provided that the fixing means is configured as an adhesive tape and this is glued around the end section of the cable armoring. For example, the fixing means configured as adhesive tape is used to bond the cable armoring to a cable core, for example comprising a sheath and/or at least one core.

The fixing means is connected to the cable armoring at least partially on or along the cable extension next to the support means. Preferably, the cable armoring is deformed in such a way by the fixing means that the support means is prevented from slipping out from under the cable armoring.

In an exemplary embodiment of the method for assembling a support sleeve system with a cable, the cable is stripped in a first step, exposing an end section of the cable armoring. In an exemplary embodiment, the fixing means and the support means are threaded onto the cable. In a further step, the fixing means is pushed over the cable armoring, for example. The support means is then pushed at least partially under the cable armoring. As an example, the fixing means is then placed on the circumferential shoulder of the support means, so that the end section of the cable armoring is at least partially arranged between the support means and the fixing means. In a further exemplary step, the fixing means is crimped or crimped so that a force-fit and/or form-fit connection is created between the fixing means, cable armoring and support means.

Furthermore, a method for assembling a threaded cable gland is proposed, which comprises the steps of: assembling, preferably pre-assembling, a support sleeve system on a cable as described above; and threading a cable gland onto the cable in such a way or inserting the cable with the assembled support sleeve system into a threaded cable gland in such a way that at least one contact element makes electrical contact with the cable armoring in the region of the support means of the support sleeve system and/or makes electrical contact with the fixing means of the support sleeve system.

In one embodiment, the pre-assembled cable is mounted with a threaded cable gland after pre-assembly. In an exemplary embodiment, a threaded cable gland is arranged on the cable. The threaded cable gland comprises two contacting means, both of which contact the cable armoring in the region of the support means. The support means creates an abutment that enables secure contacting by means of the spring-shaped contacting means.

In a further exemplary embodiment of the threaded cable gland, the cable is positioned with the support sleeve system in such a way that a first contacting means makes contact with the cable armoring in the region of the support means. A second contacting means makes contact with the fixing means, which is electrically connected to the cable armoring.

Furthermore, a cable with a support sleeve system described above is proposed, wherein a support means of the support sleeve system is arranged at least partially under a stripped cable armoring of the cable and wherein an end section of the cable armoring is arranged in a fixing means of the support sleeve system and is fixed by means of the fixing means.

The proposed cable preferably comprises the support sleeve system in an assembled state.

The support sleeve system preferably comprises at least one fixing means and one support means, the support means being arranged under the cable armoring and the fixing means for fixing the support means being applied to at least one end section of the cable armoring.

The fixing means is configured as a crimping sleeve, for example. A fixing means configured as a crimping sleeve has the advantage that the support sleeve system is permanently attached to the cable by means of this. A permanent, in particular non-destructively detachable, fastening of the support sleeve system to the cable can also be achieved by configuring the fixing means as a shrink tube or crimping sleeve, for example.

An outer diameter of the cable armoring of the cable arranged around the support means is preferably defined by the support means in the region of the support means.

The fixing means is used to fix the support means in place. In particular, the fixing means prevents the support means from slipping out from under the cable armoring. Furthermore, in one embodiment, the fixing means is advantageously arranged at least partially on the support means, so that the support means is at least partially crimped together with the fixing means. Advantageously, this prevents the support means from slipping on the cable.

The fixing means is applied to an end section of the cable armoring. Preferably, an end section of the cable armoring is covered by the fixing means. This advantageously prevents damage to the end section of the cable armoring, in particular a stripped cable armoring.

In one embodiment, it is provided that the support means is arranged in the fixing means. Preferably, the support means is arranged in the receptacle of the fixing means. Preferably, the fixing means is arranged above the support means. For example, the fixing means is threaded onto the cable. The support means is also threaded onto the cable, whereby this is arranged at least partially under the cable armoring.

In one embodiment, it is provided that the cable armoring is crimped to the support means by means of the fixing means. In an additional embodiment, it is provided that the cable armoring is pressed onto the support means by means of the fixing means, i.e. that a force is applied by means of the fixing means, which holds the cable armoring in a force-fit manner on the support means. Preferably, the fixing means presses onto the cable armoring by means of an elastic force. This advantageously achieves a defined, preferably permanent connection between the cable armoring and the support sleeve system.

In one embodiment, it is provided that the fixing means comprises an inner wall and the support means comprises an outer wall, wherein the inner wall and the outer wall are arranged substantially concentrically to one another. In particular, the support means and fixing means are arranged concentrically on top of each other when they are crimped or pressed together. For example, support means and fixing means are arranged concentrically to one another if the cable armoring is fixed to the support means by means of the fixing means, for example crimped or pressed together with the support means.

In one embodiment, it is provided that the support means comprises an outwardly projecting, at least partially circumferential shoulder on which the fixing means is placed. In this embodiment, the support means and fixing means are advantageously positioned optimally in relation to each other. Preferably, the fixing means is placed on or against the at least partially circumferential shoulder of the support means, in particular when the support means is arranged in the receptacle of the fixing means. Preferably, the cable armoring is arranged between the support sleeve and the fixing means. In addition, the cable armoring is preferably placed substantially against the shoulder of the support means.

Furthermore, a threaded cable gland with an above-mentioned cable with a support sleeve system is proposed, wherein at least one contact element of the threaded cable gland contacts a cable armoring of the cable and/or a support sleeve system.

In one embodiment, support means and/or fixing means comprise an electrically conductive material. Advantageously, support means and/or fixing means are electrically connected to the contact element, in particular to conduct electrical currents.

An exemplary threaded cable gland that can be arranged on the cable comprises two contacting means, both of which contact the cable armoring in the region of the support means. The support means creates an abutment that enables secure contacting by means of the preferably spring-shaped contacting means.

In a further exemplary embodiment of the threaded cable gland, it can be positioned in such a way that a first contacting means makes contact with the cable armoring in the region of the support means. A second contacting means makes contact with the fixing means, which is electrically connected to the cable armoring.

In a further exemplary embodiment, the threaded cable gland has exactly one contacting means, which is electrically connected to the cable armoring in the region of the support means or to the fixing means.

Furthermore, the use of a support sleeve system as defined above for pre-assembly on a cable is proposed. In one embodiment, it is provided that the cable pre-assembled with the support sleeve system is used with a threaded cable gland.

Furthermore, the use of an above-mentioned support sleeve system as a counter bearing and/or contact surface for electrical contacting with a contact element of a threaded cable gland is proposed.

In one embodiment, the contact element exerts a force on the cable armoring in order to make electrical contact with the cable. In order to counteract deformation of the cable armoring, the support sleeve system, in particular the support means, preferably acts as a counter bearing for the force applied directly to the cable armoring by the contact element. If the contact element contacts the cable armoring directly, the contact element and cable armoring are in direct contact. Preferably, a force flow is effected from the contact element through the cable armoring into the support means. In a preferred embodiment, the fixing means acts directly as a counter bearing for the contact element, namely when the contact element contacts the cable at least partially in the area of the fixing means. Preferably, a force flow es effected from the contact element through the fixing means and through the cable armoring into the support means. In a further embodiment, in which the contact element is arranged along a cable extension below the support element on the cable, a force flow is effected from the contact element through the fixing means to the cable armoring. In a further embodiment, a flow of force occurs both through the fixing means onto the cable armoring and via the fixing means through the cable armoring into the support means, namely when the fixing means is connected to the cable armoring partly below and partly on the support means along a cable extension. By using the support sleeve system as a counter bearing, cables with the same contacting properties can be advantageously produced.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A, 1B, 1C, and 1D show a support sleeve system in various installed states;

FIGS. 2A, 2B, 2C, and 2D are partial cross-sectional views of the support sleeve system of FIGS. 1A, 1B, 1C, and 1D;

FIG. 3 is a sectional view of portion III of FIG. 2A;

FIG. 4 is a sectional view of portion IV of FIG. 3; and

FIGS. 5A, 5B, 50, 5D and 5E show process steps for assembling a support sleeve system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

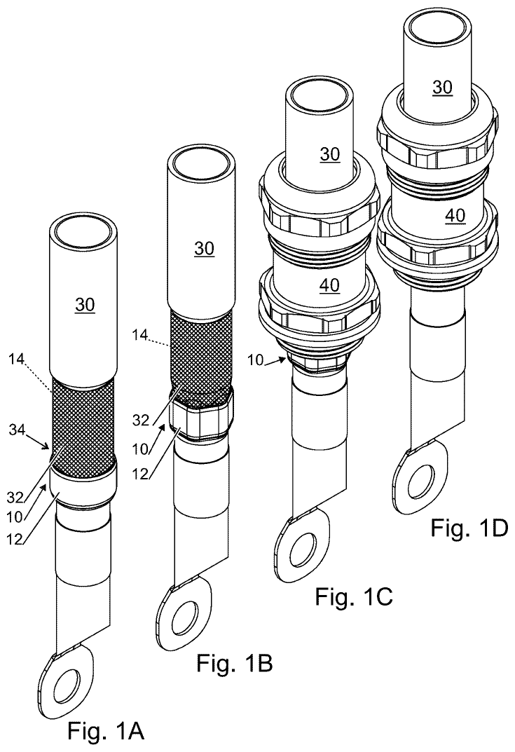

FIGS. 1A, 1B, 1C, and 1D show a support sleeve system 10 in different assembly states. In FIG. 1A, a support means 14 of the support sleeve system 10 is arranged under an end section 34 of a cable armoring 32 of a cable 30. The support means 14 is therefore not recognizable in FIG. 1A and the reference sign is therefore provided with a dashed line. The cable armoring 32 is widened in a defined manner in the region of the support sleeve system 14. A fixing means 12, which is configured as a crimping sleeve, is partially arranged over the end section 34. In FIG. 1A, the fixing means 12 is in an uncrimped state, in which it is freely movable over the cable armoring 32 and the support means 14.

In FIG. 1B, the fixing means 12 is crimped to the free end of the cable armoring 32 and the support means 14. In this way, the cable armoring 32 is securely electrically contacted and the support sleeve system 10 is firmly connected to the cable 30.

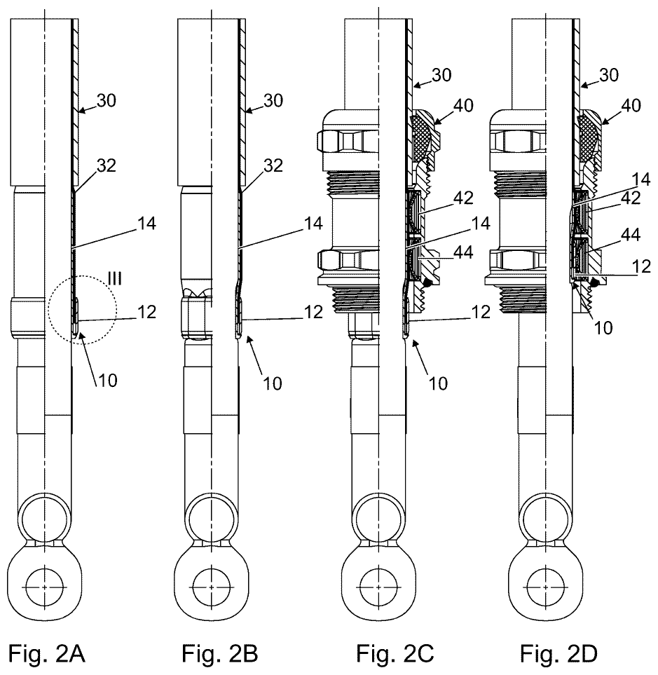

FIG. 1C and FIG. 1D each show a threaded cable gland 40 arranged in different positions on the cable 30, which is described in detail in FIG. 2C and FIG. 2D.

FIGS. 2A, 2B, 2C and 2D show the different assembly states from FIGS. 1A, 1B, 1C and 1D in a partially sectioned view. FIG. 2A shows that the support means 14 is arranged under the cable armoring 32 of the cable 30. The fixing means 12, in the uncrimped state, is arranged on the support means 14, with the cable armoring 32 being arranged at least partially between the support means 14 and the fixing means 12.

FIG. 2B shows the crimped state of the fixing means 12. The support means 14 is also deformed when the fixing means 12 is squeezed, whereby a force-fit and form-fit connection is created between the fixing means 12 and the support means 14. Furthermore, the free end of the cable armoring 32 is permanently held between the support means 14 and the fixing means 12.

FIG. 2C shows a threaded cable gland 40 arranged on the cable 30. The threaded cable gland 40 comprises two contacting means 42 and 44, both of which contact the cable armoring 32 in the region of the support means 14. An abutment is created by the support means 14, which enables secure contacting by means of the spring-shaped contacting means 42 and 44.

FIG. 2D shows an alternative arrangement of the threaded cable gland 40 on the cable 30. The threaded cable gland 40 is positioned in such a way that the contacting means 42 contacts the cable armoring 32 in the region of the support means 14. The contacting means 44 contacts the fixing means 12, which is electrically connected to the cable armoring 32.

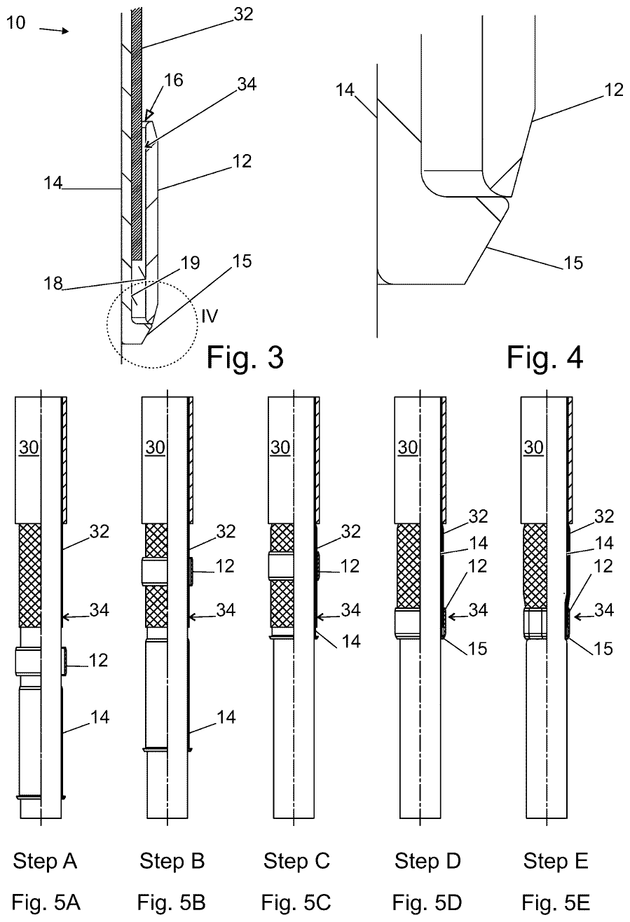

FIG. 3 shows section III from FIG. 2A. The support means comprises a circumferential shoulder 15 at its end projecting from the cable armoring 32. The shoulder 15 protrudes radially outwards to such an extent that the fixing means 12 can be placed on it. This enables optimum positioning of the fixing means 12 relative to the support means 14. The end section 34 of the cable armoring 32 is arranged in a receptacle 16 of the fixing means 12. The inner wall 18 of the fixing means 12 and the outer wall 19 of the support means 14 enclose the end section 34 of the cable armoring 32.

FIG. 4 shows section IV from FIG. 3. It can be seen that the fixing means 12 is placed on the circumferential shoulder 15 of the support means 14 in order to simplify assembly of the support sleeve system 10.

FIGS. 5A, 5B, 5C, 5D and 5E show an assembly sequence including steps A, B, C, D and E, respectively, for the assembly of a support sleeve system 10 with a cable 30 in a partially sectioned view. In step A, the cable 30 is stripped, exposing an end section 34 of the cable armoring 32. The fixing means 12 and the support means 14 are threaded onto the cable. In step B, the fixing means 12 is pushed over the cable armoring 32. In step C, the support means 14 is pushed at least partially under the cable armoring 32. Then, in step D, the fixing means 12 is placed on the circumferential shoulder 15 of the support means 14, so that the end section 34 of the cable armoring 32 is arranged at least partially between the support means 14 and the fixing means 12. In step E, the fixing means 12 is crimped or crimped so that a non-positive and positive connection is formed between the fixing means 12, the cable armoring 32 and the support means 14.

The proposed support sleeve system 10 can be used to realize a simple and safe pre-assembly of cables that can be screwed together using a threaded cable gland 40, for example. The support means 14 secured under the cable armoring 32 and the fixing means 12 create electrical abutments that enable safe and reliable electrical contacting by means of, for example, resilient contact elements 42, 44.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A support sleeve system for use as a counter bearing and/or contact surface for electrical contacting of a cable armoring, comprising:
a fixing means configured as a crimping sleeve, and
a support means, wherein the support means can be arranged under the cable armoring, wherein the support means comprises an outwardly projecting, at least partially circumferential shoulder on which the fixing means can be placed, and the fixing means can be applied to at least one end section of the cable armoring for fixing the support means.

2. The support sleeve system according to claim 1, wherein the fixing means comprises a receptacle for the at least one end section of the cable armoring.

3. The support sleeve system according to claim 1, wherein the fixing means can be arranged around the support means.

4. The support sleeve system according to claim 1, wherein the fixing means comprises an inner wall and the support means comprises an outer wall, wherein the inner wall and the outer wall can be arranged substantially concentrically to one another.

5. The support sleeve system according to claim 1, wherein the support sleeve system is used as a counter bearing and/or contact surface for electrical contacting a contact element of a threaded cable gland.

6. A method of assembling the support sleeve system according to claim 1, comprising:
stripping a cable to expose the cable armoring;
threading the fixing means of the support sleeve system and the support means of the support sleeve system onto the cable in such a way that the support means is arranged at least partially under the cable armoring and the fixing means is arranged at least partially over an end section of the cable armoring, and wherein the fixing means is placed on the circumferential shoulder of the support means so that the end section of the cable armoring is at least partially arranged between the support means and the fixing means, and force-fit and/or form-fit connecting of the fixing means to the cable armoring by means of crimping.

7. The method according to claim 6, further comprising inserting the cable with the assembled support sleeve system into a threaded cable gland in such a way that at least one contact element makes electrical contact with the cable armoring in a region of the support means of the support sleeve system and/or makes electrical contact with the fixing means of the support sleeve system.

8. A cable with the support sleeve system according to claim 1, wherein the support means of the support sleeve system is arranged at least partially under a stripped cable armoring of the cable and wherein an end section of the cable armoring is arranged in the fixing means of the support sleeve system and is fixed by means of the fixing means.

9. A threaded cable gland with the cable with the support sleeve system according to claim 8, wherein at least one contact element of the threaded cable gland contacts the cable armoring of the cable and/or the support sleeve system.
